(19) United States
(12) Patent Application Publication
(10) Pub. No.: US 2025/0082040 A1
(43) Pub. Date: Mar. 13, 2025

(54) AEROSOL GENERATING DEVICE AND OPERATING METHOD THEREOF

(71) Applicant: KT&G CORPORATION, Daejeon (KR)

(72) Inventors: Yong Hwan KIM, Gyeonggi-so (KR); Soung Ho JU, Daejeon (KR); Young Bum KWON, Gyeonggi-do (KR); Dong Sung Kim, Seoul (KR); Hun ll LIM, Seoul (KR)

(73) Assignee: KT&G CORPORATION, Daejeon (KR)

(21) Appl. No.: 18/567,164

(22) PCT Filed: Jul. 31, 2023
(86) PCT No.: PCT/KR2023/011143

§ 371 Date: Dec. 5, 2023

(30) Foreign Application Priority Data
Aug. 1, 2022 (KR) 10-2022-0095288
Oct. 5, 2022 (KR) 10-2022-0127175

(51) Int. Cl. A24F 40/60; A24F 40/57

(52) U.S. Cl. CPC A24F 40/60; A24F 40/57

(57) ABSTRACT

According to an embodiment, an aerosol generating device includes a display including a display panel and a touch panel configured to receive a touch input, a battery, and a processor electrically connected to the display and the battery, wherein the processor is configured to detect that a power state of the aerosol generating device is changed to a first state and change the power state of the aerosol generating device to a second state, based on whether a touch input through the touch panel of the display is received within a threshold time after the power state is changed to the first state, the second state being distinguished from the first state. Various embodiments may be made.

### TECHNICAL FIELD

One or more embodiments relate to an aerosol generating device of controlling a state a device based on a user input and an operating method thereof.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes.

Recently, technologies have been developed that promote user convenience by controlling the state of an aerosol generating device based on a user input. In particular, there is an increasing number of technologies that improve user convenience by adding, to an aerosol generating device, a display module for receiving touch inputs.

### DISCLOSURE OF INVENTION

### Technical Problem

There is a need for an aerosol generating device capable of outputting a user interface (UI) screen through a display, based on the reception of touch inputs within a threshold time after the display is turned off.

The technical problems of the disclosure are not limited to the aforementioned description and technical problems that are not stated may be clearly understood by one of ordinary skill in the art from the embodiments described hereinafter and the attached drawings.

### Solution to Problem

According to one or more embodiments, an aerosol generating device includes a display including a display panel and a touch panel configured to receive a touch input, a battery, and a processor electrically connected to the display and the battery, wherein the processor is configured to detect that a power state of the aerosol generating device is changed to a first state and change the power state of the aerosol generating device to a second state, based on whether a touch input through the touch panel of the display is received within a threshold time after the power state is changed to the first state, the second state being distinguished from the first state.

According to one or more embodiments, an operating method of an aerosol generating device includes detecting that a power state of the aerosol generating device is changed to a first state, and changing the power state of the aerosol generating device to a second state, which is distinguished from the first state, based on whether a touch input through a touch panel of a display is received within a threshold time after the power state is changed to the first state.

### Advantageous Effects of Invention

According to one or more embodiments, a screen, which was output immediately before the display was turned off due to no inputs from the user, is identically reproduced when a touch input from a user within a threshold time. Thus, the user may easily return to the previous state of use.

Effects of the embodiments are not limited to those stated above, and effects that are not described herein may be clearly understood by one of ordinary skill in the art from the present specification and the attached drawings.

### BRIEF DESCRIPTION OF DRAWINGS

FIG. 1 is a perspective view of an aerosol generating device according to an embodiment.

FIG. 2 is a block diagram of an aerosol generating device according to an embodiment.

FIG. 3 is a flowchart of a method of controlling a power state of an aerosol generating device, according to an embodiment.

FIG. 4 illustrates an example of a method of controlling an aerosol generating device, according to an embodiment.

FIG. 5 is a flowchart of a method of controlling a power state of an aerosol generating device and a display, according to an embodiment.

FIG. 6 illustrates an example of a display state of an aerosol generating device, according to an embodiment.

FIG. 7 illustrates an example of a display state of an aerosol generating device, according to an embodiment.

FIG. 8 is a block diagram of an aerosol generating device according to another embodiment.

### BEST MODE FOR CARRYING OUT THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expressions “at least any one of a, b, and c” and “at least any one of a, b, or c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the suspector may be a magnetic body that generates heat by an external magnetic field. As the suspector is positioned inside the coil and a magnetic field is applied to the suspector, the suspector generates heat to heat an aerosol generating article. In addition, optionally, the suspector may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

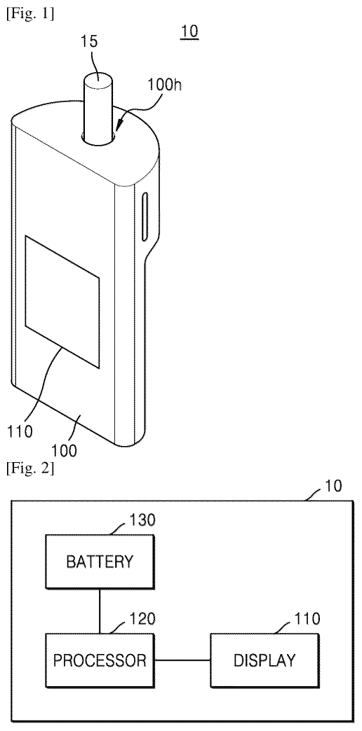

FIG. 1 is a perspective view of an aerosol generating device according to an embodiment.

Referring to FIG. 1, an aerosol generating device 10 according to an embodiment may include a housing 100 into which an aerosol generating article 15 may be inserted.

In an embodiment, the housing 120 may form a general exterior of the aerosol generating device 10 and include an inner space (or ‘an arrangement space’) in which components of the aerosol generating device 10 may be arranged. The drawing only shows that the cross-sectional shape of the housing 100 is a semicircle, but the shape of the housing 100 is not limited thereto. According to an embodiment (not shown), the shape of the housing 100 may generally be a cylinder or a polyprism (e.g., a triangular prism or a rectangular prism).

In an embodiment, components for generating aerosols by heating the aerosol generating article 15 inserted into the housing 100 and components for outputting a screen regarding the state of the aerosol generating device 10 may be arranged in the inner space of the housing 100, and the detailed descriptions thereof are provided below.

According to an embodiment, the housing 100 may include an opening 100h through which the aerosol generating article 15 may be inserted into the housing 100. At least a portion of the aerosol generating article 15 may be inserted or accommodated in the housing 100 through the opening 100h.

As the aerosol generating article 15 inserted or accommodated in the housing 100 is heated inside the housing 100, aerosols may be generated. The generated aerosols may be discharged to the outside of the aerosol generating device 10 through the inserted aerosol generating article 15 and/or a space between the aerosol generating article 15 and the opening 100h, and a user may inhale the discharged aerosols.

The aerosol generating device 10 according to an embodiment may further include a display 110 on which visual information is displayed.

In an embodiment, the display 110 may be arranged such that at least some regions of the display 110 may be exposed to the outside of the housing 100. For example, at least some regions of the display 110 may be exposed through cover glass installed on the housing.

In an embodiment, the display 110 may include a display panel and a touch panel for receiving touch inputs. For example, the display 110 may display, through the display panel, a user interface (UI) screen that changes according to a touch input received through the touch panel. In this case, the display 110 may have a stack structure of the display panel and the touch panel.

The aerosol generating device 10 may provide various pieces of visual information to the user through the display 110. For example, the aerosol generating device 10 may display, through the display 110, information regarding the preheating and heating of the aerosol generating article 15, remaining battery amount information, time and date information, usage mode information, weather information, Bluetooth connection information, etc. The information displayed through the display 110 is an example and is not limited thereto.

FIG. 2 is a block diagram of an aerosol generating device according to an embodiment.

Referring to FIG. 2, the aerosol generating device 10 may include a display 110, a processor 120, and a battery 130. Components of the aerosol generating device 10 are not limited thereto, and according to one or more embodiments, other components may be added thereto or at least one component may be omitted.

In an embodiment, the display 110 may include the touch panel and the display panel. For example, the display panel may include scan lines, data lines, organic light-emitting diodes (OLEDs) emitting light based on signals provided through the scan lines and the data lines, and light-emitting diodes (LEDs). The touch panel may detect a change in electrical characteristics (e.g., a capacitance, radio waves, etc.) according to the touch input from the user and transmit, to the processor 120, location information including the detected change.

In an embodiment, according to the power state of the aerosol generating device 10, at least one of the display 110 may operate or may be blocked.

In an embodiment, when the power state of the aerosol generating device 10 is a first state, the processor 120 may block the power supply from the battery 130 to the display panel included in the display 110, and thus, the operation of the display panel may be blocked.

In this case, the term ‘first state’ may indicate that the aerosol generating device 10 is in a low-power state (that is, a power saving state). For example, when no input is received for a certain period of time while the aerosol generating device 10 waits for a user input, the power state of the aerosol generating device 10 may be changed to the ‘first state’ that is the low-power state. The certain period of time may be set by the user and may be in a range, for example, from 1 minute to 30 minutes, but one or more embodiments are not limited thereto.

As another example, the processor 120 may supply power from the battery 130 to the display panel included in the display 110, and thus, the display panel may operate.

In this case, the term ‘second state’ may indicate that the aerosol generating device 10 is in a standby state. For example, when a user input is received while the aerosol generating device 10 is in the low-power state, the power state of the aerosol generating device 10 may be changed to the ‘second state’ that is the standby state.

In an embodiment, the display 110 may display a UI screen including visual information regarding the state of the aerosol generating device 10.

In an embodiment, the processor 120 may output a UI screen guiding the user to set a usage mode of the aerosol generating device 10 through the display 110. In this case, the term ‘usage mode’ may refer to a heating profile corresponding to a type of an aerosol generating article inserted into the aerosol generating device 10.

For example, a ‘first usage mode’ may be a heating profile for when an aerosol generating article inserted into the aerosol generating device 10 includes a tobacco material of a cut tobacco type, a ‘second usage mode’ may be a heating profile for when the inserted aerosol generating article includes a tobacco material of a granule type, and a ‘third usage mode’ may be a heating profile for when the inserted aerosol generating article includes a tobacco material of a liquid type. However, types of usage modes are not limited thereto.

The aerosol generating device 10 may heat an aerosol generating article (not shown), based on the usage mode that is set. For example, when the usage mode of the aerosol generating device 10 is set to be the ‘first usage mode,’ the processor 120 may supply power to the heater, based on the heating profile that is set in advance for the aerosol generating article including the tobacco material of the cut tobacco type. As another example, when the usage mode of the aerosol generating device 10 is set to be the ‘second usage mode,’ the processor 120 may supply power to the heater, based on the heating profile that is set in advance for the aerosol generating article including the tobacco material of the granule type. As another example, when the usage mode of the aerosol generating device 10 is set to be the ‘third usage mode,’ the processor 120 may supply power to the heater, based on the heating profile that is set in advance for the aerosol generating article including the tobacco material of the liquid type.

As another example, the display 110 may display an initial UI screen of the aerosol generating device 10.

For example, when the display panel included in the display 110 operates based on an input through the physical button of the aerosol generating device 10, the processor 120 may output the initial UI screen through the display 110. In this case, the ‘initial UI screen’ may be referred to as the ‘home screen’ and include an object (or an icon) regarding at least one piece of information (e.g., time information, information regarding a currently set usage mode, remaining battery amount information, weather information, Bluetooth connection information, etc.).

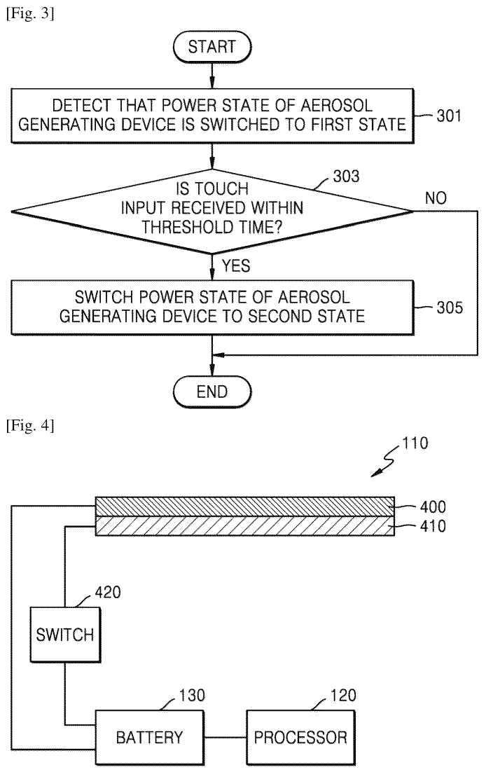

FIG. 3 is a flowchart of a method of controlling a power state of an aerosol generating device, according to an embodiment. In the description of FIG. 3, the descriptions that correspond to, are the same as, or similar to those provided above may be omitted.

Referring to FIG. 3, in operation 301, a processor (e.g., the processor 120 of FIG. 2) of an aerosol generating device (e.g., the aerosol generating device 10 of FIG. 1) may detect that the power state of the aerosol generating device 10 is switched to the first state.

In an embodiment, the power state of the aerosol generating device 10 may be switched to the first state under certain conditions. In this case, the ‘first state’ may indicate that the aerosol generating device 10 is in a low-power state. In more detail, the ‘first state’ may refer to a state in which the power supply to the display panel of the display (e.g., the display 110 of FIG. 2) is blocked.

The above-mentioned ‘certain condition’ may be satisfied when no inputs are made to an interface (e.g., a touch panel of the display, a physical button, a charging terminal, or the like) of the aerosol generating device 10 for a certain period of time. For example, when an input, such as a touch input from a user, an input through the physical button, and the insertion of the charging terminal, is not received for a certain period of time after the aerosol generating device 10 is powered on, the power state of the aerosol generating device 10 may be switched to the first state that is the low-power state.

In an embodiment, the processor 120 may detect, through a separate component (e.g., a timer), whether the power state of the aerosol generating device 10 satisfies the certain condition and is changed to the first state.

For example, when ‘the certain condition’ is satisfied when no inputs are made to an interface (e.g., the touch panel, the physical button, the charging terminal, etc.) of the aerosol generating device 10 for a certain period of time (e.g., 15 minutes), the processor 120 may detect, through the timer, whether an input to the interface is received for 15 minutes from a point in time when the power of the aerosol generating device 10 is turned on. In this case, the certain period of time may be set by the user and may be in a range, for example, of 1 minute to 30 minutes, but one or more embodiments are not limited thereto.

According to an embodiment, in operation 303, the processor 120 may detect whether a touch input through a touch panel of the display 110 is received within the threshold time.

For example, when the threshold time is set to 5 seconds, the processor 120 may detect whether a touch input through the touch panel of the display 110 is received within five seconds from a point in time when the power state of the aerosol generating device 10 is switched to the first state (that is, the point in time when the operation of the display panel is blocked), through a timer.

According to an embodiment, when a touch input through the touch panel of the display 110 is received within the threshold time, the processor 120 may switch, in operation 305, the power state of the aerosol generating device 10 to a second state distinguished from the first state. In this case, the ‘second state’ may refer to a state in which power is supplied to the display panel of the display 110.

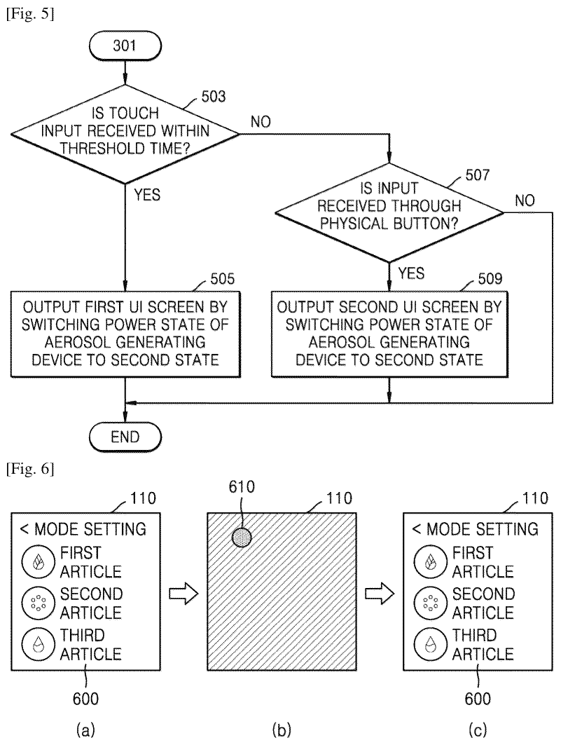

In an embodiment, the processor 120 may switch the power state of the aerosol generating device 10 to the second state and also output a UI screen through the display panel of the display 110. For example, while switching the power state of the aerosol generating device 10 to the second state, the processor 120 may output a UI screen that was output immediately before the power state of the aerosol generating device 10 changed to the first state in operation 301. The detailed description regarding the UI screen that is output through the display panel is described below with reference to FIGS. 5 and 6.

According to an embodiment, when no touch input through the touch panel of the display 110 is received within the threshold time, the processor 120 may maintain the power state of the aerosol generating device 10 to the first state.

FIG. 4 illustrates an example of a method of controlling an aerosol generating device, according to an embodiment.

Referring to FIG. 4, the aerosol generating device (e.g., the aerosol generating device 10 of FIG. 1) may include a display 110, a processor 120, and a battery 130, and the display 110 may include a touch panel 400 for receiving a touch input from a user and a display panel 410.

In an embodiment, the battery 130 may be directly connected to the touch panel 400, and the battery 130 may be connected to the display panel 410 through a switch 420.

In an embodiment, as the power state of the aerosol generating device 10 is changed to the first state, the processor 120 may block the power supply to the display panel 410 while maintaining the power supply to the touch panel 400 through the battery 130. In this case, the disconnection of the power supply to the display panel 410 may indicate that the switch 420 located between the display panel 410 and the battery 130 is changed from a closed state to an open state.

In an embodiment, the processor 120 may detect whether a touch input through the touch panel 400 is received within the threshold time. For example, when the threshold time is set to 5 seconds, the processor 120 may detect whether a touch input through the touch panel 400 is received within five seconds from a point in time when the power state of the aerosol generating device 10 is switched to the first state, through the timer.

In an embodiment, when a touch input through the touch panel 400 is received within the threshold time, the processor 120 may initiate the power supply to the display panel 410 while maintaining the power supply to the touch panel 400. In this case, the initiation of the power supply to the display panel 410 may indicate that the switch 420, which is arranged between the display panel 410 and the battery 130, is switched from the open state to the closed state.

In another embodiment, when no touch input through the touch panel 400 is received within the threshold time, the processor 120 may block the power supply to the touch panel 400 while keeping shutting off the power to the display panel 410. In this case, the disconnection of the power supply to the touch panel 400 may indicate that the power supply from the battery 130 to the display 110 is blocked.

FIG. 5 is a flowchart of a method of controlling a power state of an aerosol generating device and a display, according to an embodiment. FIG. 5 is a detailed flowchart of operations after operation 301 of FIG. 3.

Referring to FIG. 5, the processor (e.g., the processor 120 of FIG. 2) of the aerosol generating device (e.g., the aerosol generating device 10 of FIG. 1) may detect, in operation 503, whether a touch input through a touch panel of the display (e.g., the display 110 of FIG. 2) is received within the threshold time.

For example, when the threshold time is set to 5 seconds, the processor 120 may detect whether a touch input through the touch panel (e.g., the touch panel 400 of FIG. 4) of the display 110 is received within five seconds from a point in time when the power state of the aerosol generating device 10 is switched to the first state (that is, the point in time when the operation of the display panel is blocked), through a timer.

According to an embodiment, when a touch input through the touch panel 400 of the display 110 is received within the threshold time, the processor 120 may change the power state of the aerosol generating device 10 to the second state and output a first UI screen through the display panel (e.g., the display panel 410 of FIG. 4), in operation 505. In this case, the ‘first UI screen’ may refer to a UI screen that was output through the display panel 410 immediately before the power state of the aerosol generating device 10 was changed to the first state.

For example, assume that the processor 120 was outputting a ‘settings’ screen through the display panel 410 when the power state of the aerosol generating device 10 changed to the first state. Then, the operation of the display panel 410 may be blocked as the power state of the aerosol generating device 10 is switched to the first state. In this case, when a touch input through the touch panel 400 is received within the threshold time, the processor 120 may output the ‘settings’ screen as the first UI screen through the display panel 410, because the ‘settings’ screen was being output right before the operation of the display panel 410 stopped.

According to an embodiment, when no touch input through the touch panel 400 of the display 110 is received within the threshold time, the processor 120 may detect, in operation 507, whether an input through a physical button is received. For example, the physical button may be formed to protrude from the housing (e.g., the housing 100 of FIG. 1) of the aerosol generating device 10.

According to an embodiment, when an input through the physical button is received, the processor 120 may change the power state of the aerosol generating device 10 to the second state and output a second UI screen through the display panel 410, in operation 509. In this case, the ‘second UI screen’ may indicate an initial UI screen of the aerosol generating device 10 which includes an object regarding at least one of time information, a usage mode, remaining battery amount information, and weather information.

For example, assume that the processor 120 was outputting the ‘settings’ screen through the display panel 410 when the power state of the aerosol generating device 10 changed to the first state. Then, the operation of the display panel 410 may be blocked as the power state of the aerosol generating device 10 is switched to the first state. In this case, when no touch input through the touch panel 400 is received within the threshold time and then an input through the physical button is received, the processor 120 may output, as the second UI screen, the ‘home screen’ (that is, the initial screen) including the object regarding at least one of the time information, the usage mode, the remaining battery amount information, and the weather information.

According to an embodiment, when no input through the physical button is received, the processor 120 may maintain the first state of the aerosol generating device 10.

FIG. 6 illustrates an example of a display state of an aerosol generating device, according to an embodiment.

Referring to FIG. 6, the display 110 may output a first UI screen 600 through the display panel (e.g., the display panel 410 of FIG. 4), as illustrated in the state (a). In this case, the display panel 410 and the touch panel (e.g., the touch panel 400 of FIG. 4) of the display 110 may receive power from the battery (e.g., the battery 130 of FIG. 2).

In an embodiment, the first UI screen 600 may be a ‘usage mode setting’ screen including objects corresponding to respective usage modes. The objects respectively corresponding to the usage modes may allow the user to make a touch input to select a usage mode. In this case, the ‘usage mode’ may refer to a heating profile corresponding to a type of an aerosol generating article inserted into the aerosol generating device (e.g., the aerosol generating device 10 of FIG. 1).

However, the ‘usage mode setting’ screen is merely an example of the first UI screen 600, and the first UI screen 600 may be any one of various execution screens of the aerosol generating device 10.

In FIG. 6, the phrase ‘first article’ and an icon next to the phrase may indicate a usage mode in which an aerosol generating article including a tobacco material of a cut tobacco type is heated and may guide a touch input from the user.

The phrase ‘second article’ and an icon next to the phrase may indicate a usage mode in which an aerosol generating article including a tobacco material of a granule type is heated and may guide a touch input from the user.

The phrase ‘third article’ and an icon next to the phrase may indicate a usage mode in which an aerosol generating article including a tobacco material of a liquid type is heated and may guide a touch input from the user.

In an embodiment, when no touch input through the touch panel 400 of the display 110 is received for a certain period of time from a point in time when the output of the first UI screen 600 is initiated, the power state of the aerosol generating device 10 may be is changed to the first state. In this case, a screen output through the display panel 410 may stop, as illustrated in the state (b). Also, the power supply to the display panel 410 of the display 110 may be blocked, while the power supply to the touch panel 400 is maintained during the threshold time.

In an embodiment, the display 110 may receive the touch input 610 through the touch panel 400 during the threshold time (i.e., while the power supply to the touch panel 400 is maintained). In this case, the touch input 610 may include at least one touch input. For example, the touch input 610 may be a single touch input or a double touch input, but types of the touch inputs 610 are not limited thereto.

In an embodiment, as the touch input 610 through the touch panel 400 is received during the threshold time, the display 110 may output the first UI screen 600 through the display panel 410, as illustrated in the state (c). That is, the display 110 may identically output a UI screen which was output immediately before the operation of the display panel 410 was blocked, if the touch input 610 is received through the touch panel 400 of the display 110 within the threshold time. Thus, the user may easily return to the previous state of use.

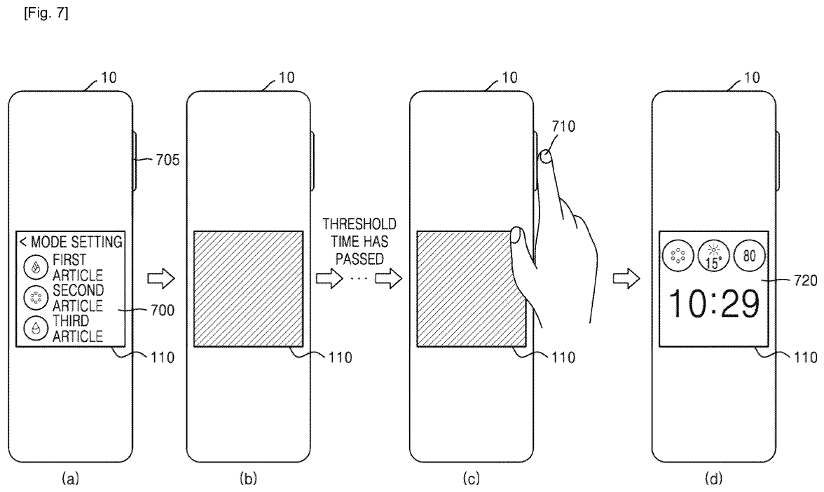

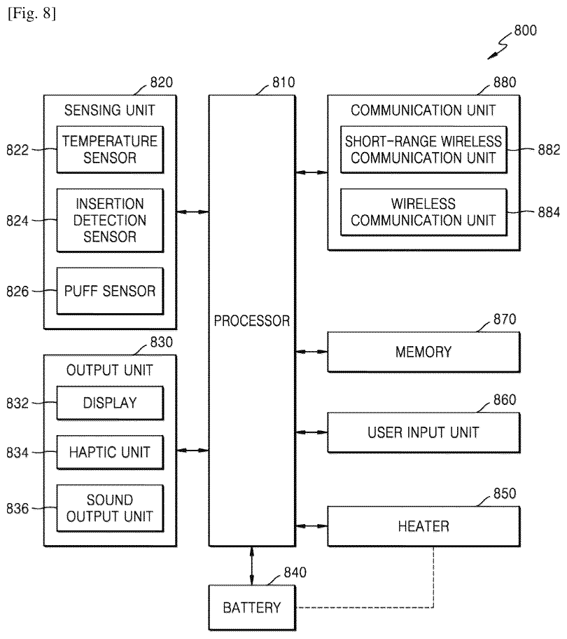

FIG. 7 illustrates an example of a display state of an aerosol generating device, according to an embodiment.

Referring to FIG. 7, the display 110 may output a first UI screen 700 through the display panel (e.g., the display panel 410 of FIG. 4), as illustrated in the state (a). In this case, the display panel 410 and the touch panel (e.g., the touch panel 400 of FIG. 4) of the display 110 may receive power from the battery (e.g., the battery 130 of FIG. 2).

In an embodiment, the first UI screen 700 may be a ‘usage mode setting’ screen including objects corresponding to respective usage modes, and the objects respectively corresponding to the usage modes may be objects for guiding the touch inputs from the user. In this case, the ‘usage mode’ may refer to a heating profile corresponding to a type of an aerosol generating article inserted into the aerosol generating device (e.g., the aerosol generating device 10 of FIG. 1). Because the first UI screen 700 of FIG. 7 may correspond to the first UI screen 600 of FIG. 6, the detailed description regarding the first UI screen 700 may be omitted.

In an embodiment, if no touch input through the touch panel 400 of the display 110 is received for a certain period of time from a point in time when the output from the first UI screen 700 is initiated, as the power state of the aerosol generating device 10 is changed to the first state, the display 110 may stop outputting a screen through the display panel 410 as illustrated in the state (b). In this case, the power supply to the display panel 410 of the display 110 may be blocked, and the power supply to the touch panel 400 may be maintained during the threshold time.

In an embodiment, when no touch input through the touch panel 400 is received during the threshold time when the power supply to the touch panel 400 of the display 110 is maintained, the power supply to the touch panel 400 may be blocked.

In an embodiment, the aerosol generating device 10 may receive an input 710 through a physical button 705, as illustrated in the state (c). In this case, the input 710 through the physical button 705 may include at least one of a touch input and a mechanical input. For example, the input 710 through the physical button 705 may be a mechanical input (push) to a push button. As another example, the input 710 through the physical button 705 may be a touch input to a touch sensor embedded in the push button and a mechanical input to the push button.

In an embodiment, as the input 710 through the physical button 705 is received, the display 110 may output a second UI screen 720 through the display panel 410 as illustrated in the state (d). In this case, the power supply to the display panel 410 and the touch panel 400 of the display 110 may be initiated.

In an embodiment, the second UI screen 720 may be the ‘initial UI screen’ of the aerosol generating device 10 and may include objects corresponding to at least one piece of information (e.g., time information, information regarding a currently set usage mode, remaining battery amount information, weather information, Bluetooth connection information, or the like). However, the types of information included in the second UI screen 720 are merely examples, and the second UI screen 720 may include objects corresponding to at least one of various pieces of information of the aerosol generating device 10.

FIG. 8 is a block diagram of an aerosol generating device 800 according to another embodiment.

The aerosol generating device 800 may include a controller 810, a sensing unit 820, an output unit 830, a battery 840, a heater 850, a user input unit 860, a memory 870, and a communication unit 880. However, the internal structure of the aerosol generating device 800 is not limited to those illustrated in FIG. 8. That is, according to the design of the aerosol generating device 800, it will be understood by one of ordinary skill in the art that some of the components shown in FIG. 8 may be omitted or new components may be added.

The sensing unit 820 may sense a state of the aerosol generating device 800 and a state around the aerosol generating device 800, and transmit sensed information to the controller 810. Based on the sensed information, the controller 810 may control the aerosol generating device 800 to perform various functions, such as controlling an operation of the heater 850, limiting smoking, determining whether an aerosol generating article (e.g., a cigarette, a cartridge, or the like) is inserted, displaying a notification, or the like.

The sensing unit 820 may include at least one of a temperature sensor 822, an insertion detection sensor, and a puff sensor 826, but is not limited thereto.

The temperature sensor 822 may sense a temperature at which the heater 850 (or an aerosol generating material) is heated. The aerosol generating device 800 may include a separate temperature sensor for sensing the temperature of the heater 850, or the heater 850 may serve as a temperature sensor. Alternatively, the temperature sensor 822 may also be arranged around the battery 840 to monitor the temperature of the battery 840.

The insertion detection sensor 824 may sense insertion and/or removal of an aerosol generating article. For example, the insertion detection sensor 824 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 826 may sense a user's puff on the basis of various physical changes in an airflow passage or an airflow channel. For example, the puff sensor 826 may sense a user's puff on the basis of any one of a temperature change, a flow change, a voltage change, and a pressure change.

The sensing unit 820 may include, in addition to the temperature sensor 822, the insertion detection sensor 824, and the puff sensor 826 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 830 may output information on a state of the aerosol generating device 800 and provide the information to a user. The output unit 830 may include at least one of a display unit 832, a haptic unit 834, and a sound output unit 836, but is not limited thereto. When the display unit 832 and a touch pad form a layered structure to form a touch screen, the display unit 832 may also be used as an input device in addition to an output device.

The display unit 832 may visually provide information about the aerosol generating device 800 to the user. For example, information about the aerosol generating device 800 may mean various pieces of information, such as a charging/discharging state of the battery 840 of the aerosol generating device 800, a preheating state of the heater 850, an insertion/removal state of an aerosol generating article, or a state in which the use of the aerosol generating device 800 is restricted (e.g., sensing of an abnormal object), or the like, and the display unit 832 may output the information to the outside. The display unit 832 may be, for example, a liquid crystal display panel (LCD), an organic light-emitting diode (OLED) display panel, or the like. In addition, the display unit 832 may be in the form of a light-emitting diode (LED) light-emitting device.

The haptic unit 834 may tactilely provide information about the aerosol generating device 800 to the user by converting an electrical signal into a mechanical stimulus or an electrical stimulus. For example, the haptic unit 834 may include a motor, a piezoelectric element, or an electrical stimulation device.

The sound output unit 836 may audibly provide information about the aerosol generating device 800 to the user. For example, the sound output unit 836 may convert an electrical signal into a sound signal and output the same to the outside.

The battery 840 may supply power used to operate the aerosol generating device 800. The battery 840 may supply power such that the heater 850 may be heated. In addition, the battery 840 may supply power required for operations of other components (e.g., the sensing unit 820, the output unit 830, the user input unit 860, the memory 870, and the communication unit 880) in the aerosol generating device 800. The battery 840 may be a rechargeable battery or a disposable battery. For example, the battery 840 may be a lithium polymer (LiPoly) battery, but is not limited thereto.

The heater 850 may receive power from the battery 840 to heat an aerosol generating material. Although not illustrated in FIG. 8, the aerosol generating device 800 may further include a power conversion circuit (e.g., a direct current (DC)/DC converter) that converts power of the battery 840 and supplies the same to the heater 850. In addition, when the aerosol generating device 800 generates aerosols in an induction heating method, the aerosol generating device 800 may further include a DC/alternating current (AC) that converts DC power of the battery 840 into AC power.

The controller 810, the sensing unit 820, the output unit 830, the user input unit 860, the memory 870, and the communication unit 880 may each receive power from the battery 840 to perform a function. Although not illustrated in FIG. 8, the aerosol generating device 800 may further include a power conversion circuit that converts power of the battery 840 to supply the power to respective components, for example, a low dropout (LDO) circuit, or a voltage regulator circuit.

In an embodiment, the heater 850 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 850 may be implemented by a metal wire, a metal plate on which an electrically conductive track is arranged, a ceramic heating element, or the like, but is not limited thereto.

In another embodiment, the heater 850 may be a heater of an induction heating type. For example, the heater 850 may include a suspector that heats an aerosol generating material by generating heat through a magnetic field applied by a coil.

The user input unit 860 may receive information input from the user or may output information to the user. For example, the user input unit 860 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 8, the aerosol generating device 800 may further include a connection interface, such as a universal serial bus (USB) interface, and may connect to other external devices through the connection interface, such as the USB interface, to transmit and receive information, or to charge the battery 840.

The memory 870 is a hardware component that stores various types of data processed in the aerosol generating device 800, and may store data processed and data to be processed by the controller 810. The memory 870 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 870 may store an operation time of the aerosol generating device 800, the maximum number of puffs, the current number of puffs, at least one temperature profile, data on a user's smoking pattern, etc.

The communication unit 880 may include at least one component for communication with another electronic device. For example, the communication unit 880 may include a short-range wireless communication unit 882 and a wireless communication unit 884.

The short-range wireless communication unit 882 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 884 may include a cellular network communication unit, an Internet communication unit, a computer network (e.g., local area network (LAN) or wide area network (WAN)) communication unit, or the like, but is not limited thereto. The wireless communication unit 884 may also identify and authenticate the aerosol generating device 800 within a communication network by using subscriber information (e.g., International Mobile Subscriber Identifier (IMSI)).

The controller 810 may control general operations of the aerosol generating device 800. In an embodiment, the controller 810 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 810 may control the temperature of the heater 850 by controlling supply of power of the battery 840 to the heater 850. For example, the controller 810 may control power supply by controlling switching of a switching element between the battery 840 and the heater 850. In another example, a direct heating circuit may also control power supply to the heater 850 according to a control command of the controller 810.

The controller 810 may analyze a result sensed by the sensing unit 820 and control subsequent processes to be performed. For example, the controller 810 may control power supplied to the heater 850 to start or end an operation of the heater 850 on the basis of a result sensed by the sensing unit 820. As another example, the controller 810 may control, based on a result sensed by the sensing unit 820, an amount of power supplied to the heater 850 and the time the power is supplied, such that the heater 850 may be heated to a certain temperature or maintained at an appropriate temperature.

The controller 810 may control the output unit 830 on the basis of a result sensed by the sensing unit 820. For example, when the number of puffs counted through the puff sensor 826 reaches a preset number, the controller 810 may notify the user that the aerosol generating device 800 will soon be terminated through at least one of the display unit 832, the haptic unit 834, and the sound output unit 836.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a display comprising a display panel and a touch panel configured to receive a touch input;
a battery; and
a processor electrically connected to the display and the battery, wherein the processor is configured to:
detect that a power state of the aerosol generating device is changed to a first state; and
change the power state of the aerosol generating device to a second state, based on whether a touch input through the touch panel of the display is received within a threshold time after the power state is changed to the first state, the second state being distinguished from the first state.

2. The aerosol generating device of claim 1, wherein the processor is further configured to block power supply from the battery to the display panel in the first state, and supply power from the battery to the display panel in the second state.

3. The aerosol generating device of claim 1, wherein the processor is further configured to change the power state of the aerosol generating device to the second state when the touch input through the touch panel is received within the threshold time, and output a first user interface (UI) screen through the display panel.

4. The aerosol generating device of claim 3, wherein the first UI screen comprises a UI screen that is output through the display panel immediately before the power state of the aerosol generating device is switched to the first state.

5. The aerosol generating device of claim 1, wherein the processor is further configured to change the power state of the aerosol generating device to the second state, based on whether an input through a physical button is received in the first state.

6. The aerosol generating device of claim 5, wherein the processor is further configured to, when the input through the physical button is received, change the power state of the aerosol generating device to the second state and output a second UI screen through the display panel.

7. The display apparatus of claim 6, wherein the second UI screen comprises an initial UI screen of the aerosol generating device, the initial UI screen comprising an object regarding at least one of time information, a usage mode, remaining battery amount information, and weather information.

8. The aerosol generating device of claim 7, further comprising a heater, wherein the usage mode is a state that is set by a user among a plurality of usage modes, and
the processor is further configured to control power supply to the heater, based on a heating profile corresponding to the usage mode among a plurality of heating profiles.

9. The aerosol generating device of claim 1, wherein the touch input through the touch panel comprises at least one touch input.

10. An operating method of an aerosol generating device, the operating method comprising:
detecting that a power state of the aerosol generating device is changed to a first state; and
changing the power state of the aerosol generating device to a second state that is distinguished from the first state, based on whether a touch input through a touch panel of a display is received within a threshold time after the power state is changed to the first state.

11. The operating method of claim 10, further comprising blocking power supply from a battery to a display panel of the display in the first state and supplying power from the battery to the display panel in the second state.

12. The operating method of claim 10, further comprising changing the power state of the aerosol generating device to the second state and outputting a first user interface (UI) screen through a display panel, as the touch input through the touch panel is received within the threshold time.

13. The operating method of claim 10, further comprising, changing the power state of the aerosol generating device to the second state, based on whether an input through a physical button is received in the first state.

14. The operating method of claim 13, further comprising changing the power state of the aerosol generating device to the second state and outputting a second UI screen through the display panel, when an input through the physical button is received.

15. A non-transitory computer-readable recording medium having stored therein a program for executing the operating method of claim 10.
